(19) United States
(12) Patent Application Publication
(10) Pub. No.: US 2015/0151188 A1
(43) Pub. Date: Jun. 4, 2015

(54) Playing Cards and Method for Playing Card Games Therewith

(71) Applicants: David L. Hoyt, Chicago, IL (US); Stephen M. Flaherty, Chicago, IL (US)

(72) Inventors: David L. Hoyt, Chicago, IL (US); Stephen M. Flaherty, Chicago, IL (US)

(21) Appl. No.: 14/528,661

(22) Filed: Oct. 30, 2014

Related U.S. Application Data
(63) Continuation of application No. 13/757,406, filed on Feb. 1, 2013, now abandoned.
Application No. 13/757,406 is a continuation of application No. 13/220,398, filed on Aug. 29, 2011, now abandoned.
Application No. 13/220,398 is a continuation of application No. 12/157,183, filed on Jun. 6, 2008, now abandoned.
Application No. 12/157,183 is a continuation-in-part of application No. 11/653,162, filed on Jan. 12, 2007, now abandoned.
Application No. 11/653,162 is a continuation of application No. 11/189,049, filed on Jul. 25, 2005, now abandoned.
Application No. 11/189,049 is a continuation of application No. 10/411,811, filed on Apr. 11, 2003, now abandoned.
Application No. 10/411,811 is a continuation of application No. 09/826,637, filed on Apr. 5, 2001, now Pat. No. 6,547,247.

(51) Int. Cl. A63F 1/00; G07F 17/32

(52) U.S. Cl. CPC A63F 1/00; G07F 17/3293; G07F 17/3262; A63F 2001/005; A63F 2001/003

(57) ABSTRACT

A novel card game in which cards are dealt and placed into a space on a three-by-three grid in order to create the most number of high-scoring poker hands out of the eight possible hands; three rows, three columns and two diagonals. Using the present invention, numerous different games can be played with one or more players and using a deck of standard playing cards, a computer, a handheld device or a gaming machine. The present invention can also be used for lottery tickets and the like.

This application is a continuation-in-part of co-pending application Ser. No. 11/653,162 filed Jan. 12, 2007, entitled PLAYING CARDS AND METHOD FOR PLAYING CARD GAMES THEREWITH which is a continuation of (now abandoned) Ser. No. 11/189,049 filed Jul. 25, 2005, entitled PLAYING CARDS AND METHOD FOR PLAYING CARD GAMES THEREWITH, which is a continuation of (now abandoned) Ser. No. 10/411,811 filed Apr. 11, 2003, entitled PLAYING CARDS AND METHOD FOR PLAYING CARD GAMES THEREWITH, which is a continuation of U.S. Ser. No. 09/826,637 filed Apr. 5, 2001, entitled PLAYING CARDS AND METHOD FOR PLAYING CARD GAMES THEREWITH, and which issued as U.S. Pat. No. 6,547,247 on Apr. 15, 2003, which was a regular filing of provisional application Ser. No. 60/195,600 filed Apr. 6, 2000.

### TECHNICAL FIELD OF THE INVENTION

The present invention relates to novel card games or gambling games that can be played with a standard deck of cards or with a novel deck of playing cards, more specifically the present invention relates to a novel card game utilizing the combination of the well known tic-tac-toe game, along with the rules of Blackjack (otherwise known as 21), or the rules of poker. In the novel game, nine playing cards are dealt to a player, one at a time from a standard deck of 52 playing cards, and the player must decide as each card is dealt where to place the card on a tic-tac-toe (3 by 3 array) board, in order to obtain the sum of 21 (when adding up three cards), either across, down or on a diagonal. The player attempts to create as many 21 totals as possible. In the novel games of poker, the cards are also placed on the board, but the player places the cards in the optimal position to obtain the best poker hand or hands.

An alternative embodiment of the present invention relates to a novel deck of playing cards made up of approximately 60 cards. The novel deck comprises six groups of ten cards, each card having a numeric value of between one and ten (i.e., six cards having the number five, six cards having the number ten, etc.). These novel cards, unlike standard cards, do not contain a suit indication, such as Spades, Hearts, Diamonds or Clubs.

Another alternative embodiment of the present invention is a novel deck of playing cards contains either 37 or 38 cards. Each playing card corresponds to a number (1 through 36, 0 and 00), and a color (black, red or green), found on a standard wheel used in a game of roulette. The novel cards may also contain other information, such as whether the card number is odd or even, and whether the number on the card pertains to the first-third of numbers, second-third, or third-third.

### BACKGROUND OF THE INVENTION

Playing cards have been in existence for many years. Although there are many types of playing cards that are played in many different types of games, the most common type of playing cards consists of 52 cards, divided out into four different suits (namely Spades, Hearts, Diamonds and Clubs) which are printed or indicated on one side or on the face of each card. In the standard deck, each of the four suits of cards consists of 13 cards, numbered either two through ten, or lettered A (Ace), K (King), Q (Queen), or J (Jack), which is also printed or indicated on the face of each card. Each card will thus contain on its face a suit indication along with a number or letter indication. The King, Queen, and Jack usually also include some sort of design on the face of the card, and may be referred to as picture cards.

In some cases, the 52 card standard playing deck also contains a number of extra cards, sometimes referred to as jokers, that may have some use or meaning depending on the particular game being played with the deck. For example, if a card game includes the jokers, then if a player receives a joker in his “hand” he may use it as any card in the deck. If the player has the ten, jack, queen and king of Spades, along with a joker, the player would use the joker as an Ace of Spades. The player will then have a Royal Flush (ten through Ace of Spades).

Many different games can be played using a standard deck of playing cards. The game being played with the standard deck of cards may include other items, such as game boards, chips, etc., or the game being played may only need the playing card deck itself. In most of the games played using a standard deck of cards, a value is assigned to each card. The value may differ for different games.

Usually, the card value begins with the number two card as the lowest value and increases as the numbers increase through ten, followed in order of increasing value with the Jack, Queen, King and Ace. In some games the Ace may have a lower value than the two, and in games where a particular card is determined to be wild, or have any value, that card may have the greatest value of all. For example, in card games where deuces, or twos, are wild, the player holding a playing card containing a two can use that two as any other card, such that a nine and a two would be the equivalent of two nines.

Further, the four different suits indicated on the cards may have a particular value depending on the game. Under game rules where one suit, i.e., Spades, has more value than another suit, i.e., Hearts, the seven of Spades may have more value than the seven of Hearts.

It is easy to visualize that using the different card quantity and suit values, many different games can be played. In certain games, it is the combination of cards that one player obtains that determines whether or not that player has defeated the other player or players. Usually, the more difficult the combination is to obtain, the more value the combination has, and the player who obtains the more difficult combination (also taking into account the value of the cards) wins the game.

For instance in the game of Poker, each player may ultimately receive five cards. The player who obtains three cards having similar numbers on their face, i.e., the four of Hearts, four of Diamonds and four of Clubs, will defeat the player having only two cards with the same numerical value, i.e., the King of Spades and the King of Hearts. However, the player with five cards that all contain Clubs, commonly known as a flush, will defeat the player with the same three of a kind described above.

In many instances, a standard deck of playing cards is used to create gaming machines. In these gaming machines players insert coins and play certain card games, such as poker, using an imitation of standard playing cards on a video screen, in an attempt to win back more money than they originally inserted into the machine.

Another form of gambling using playing cards utilizes tables, otherwise known as table games. A table uses a table and a dealer, with the players sitting or standing around the table. The players place their bets on the table and the dealer deals the cards to each player. The number of cards dealt, or whether the cards are dealt face up or face down, will depend on the particular table game being played.

Further, an imitation or depiction of a standard playing card is used in many handheld electronic games, such as poker and Blackjack, and in many computer games and Internet games. Using a handheld electronic game or a computer terminal that may or may not be connected to the Internet, a player receives the imitation playing cards and plays a card game either against the computer or against other players. Further, many of these games can be played on the computer in combination with gambling.

Also, there are many game shows that are broadcasted on television that use a deck of playing cards in the game play, in which the cards are usually enlarged or shown on a video screen or monitor for easy viewing. In these television game shows, the participants play the card game for prizes or money, usually against each other, with an individual acting as a host overseeing the action.

Also, there are lottery tickets that players purchase and play by “scratching off” an opaque layer to see if they have won money and prizes. The opaque layer prevents the player from knowing the results of the lottery ticket prior to purchasing and scratching off the layer. In some of these lottery tickets, playing cards are used under the opaque layer and the player may need to match a number of similar cards in order to win the prizes or money.

### BRIEF SUMMARY OF THE INVENTION

In the present invention, a novel board game and/or gambling game that can be played with a standard deck of playing cards utilizing the combination of tic-tac-toe with the rules of Blackjack or 21. Nine cards are dealt, one at a time, from a standard deck of playing cards (52 cards having 13 cards per each of four suits). The player must decide, as each card is dealt, where to place the card on an enlarged tic-tac-toe board. The object is to obtain a sum of 21 either across, down or on the diagonals.

An object of the present invention is to provide a method for playing the game of Blackjack in which nine standard playing cards are dealt to the player, and the player places the cards on an exaggerated (in size) tic-tac-toe board in an attempt to obtain totals of 21 when adding three cards (either across, down or diagonal). The player positions the cards such that as many totals of 21 can be obtained.

Another object of the present invention is to provide a method for playing the game of poker in which nine standard playing cards are dealt to the player, and the player places the cards on an exaggerated (in size) tic-tac-toe board in an attempt to obtain the highest value poker hand using three cards (either across, down or diagonal). The player positions the cards such that each set is a separate poker hand.

Another aspect of the present invention relates to a deck of playing cards made up of 60 individual cards, divided into six groups of ten cards per group. Each card of each group has a numeric value of between one and ten (i.e., six cards having the number five, six cards having the number ten, etc.). These cards do not necessarily need a suit indication (club, spade, diamond or heart) as found on cards from a standard playing deck of cards. Other combinations of numeric values and group numbers can be used, such as ten groups of cards each card containing the numeric value of between one and seven.

Another aspect of the present invention relates to a novel deck of playing cards containing novel cards, each card corresponding to a number (one through 36, 0 or 00), or a color (black, red or green). This information is similar to some of the information found on a standard roulette wheel and table board. If there is only one “zero” card, then the deck contains 37 cards; if there is a “double-zero” card, the deck will contains 38 cards.

Each of these novel games can be played using actual playing cards from a standard or modified deck as described herein, or the games can be played by simulating the dealing of cards on a display, such as a computer screen or a handheld electronic game. Further, the basis of these novel games can be depicted in scratch off lottery cards and the like.

### BRIEF DESCRIPTION OF THE DRAWINGS

FIG. 1 is a front view of nine playing cards located on the playing board after playing a version of the game embodying the present invention;

FIG. 2 is a front view of nine playing cards located on the playing board after playing a version of the game embodying the present invention;

FIG. 3 is a front view of nine playing cards located on the playing board after playing a version of the game embodying the present invention;

FIG. 4 is a front view of nine playing cards located on the playing board after playing a version of the game embodying the present invention;

FIG. 5 is a front view of a single playing card from an alternative novel deck of playing cards embodying the to present invention;

FIG. 6 is a front view of a single playing card from an alternative novel deck of playing cards embodying the present invention.

### DETAILED DESCRIPTION OF THE INVENTION

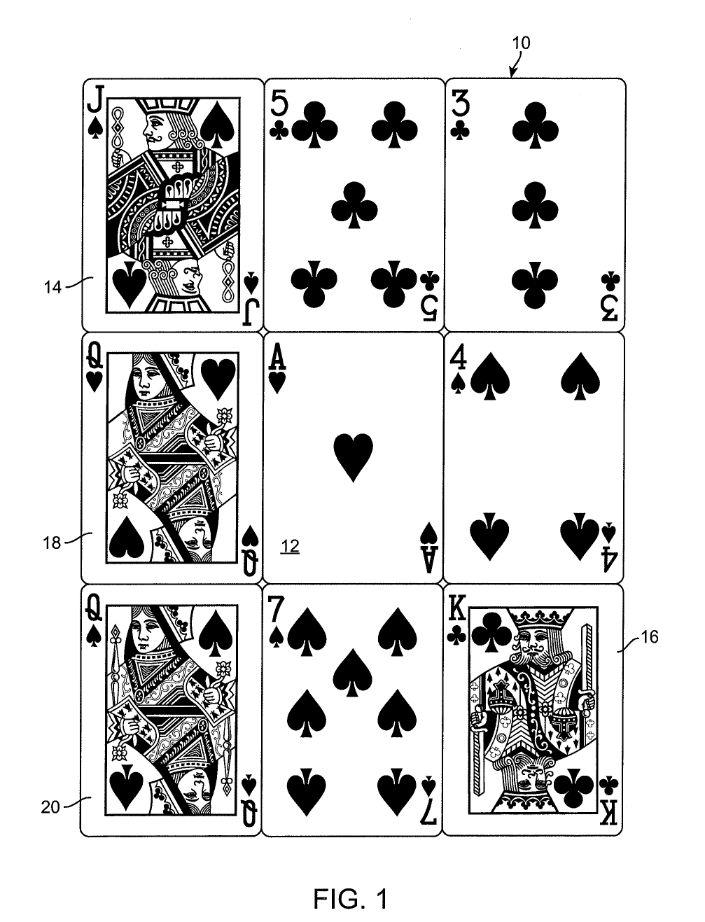

The present invention relates to a novel board game and/or gambling game and method that can be played with a standard deck of playing cards utilizing the combination of the well known game of tic-tac-toe, along with the rules of Blackjack (otherwise known as 21). The object of the game is to obtain a sum of 21, or as many 21s as possible, across, down or on the diagonals, as nine cards are dealt, one at a time, from a standard deck of playing cards (52 cards having 13 cards per each of four suits). FIG. 1 shows the final layout of the cards 10 in the tic-tac-toe arrangement in accordance with the present invention.

At the beginning of the game, an empty board (not shown) containing a three by three array, similar to a tic-tac-toe board, is laid out. The game can be played without a board and instead just approximate where the nine different positions are located. As understood by those having ordinary skill in the art, the game can also be played or simulated on a computer, an electronic handheld device or a gaming machine. Using an electronic display (especially using a touch screen), allows the player to indicate where the cards should be placed to optimize scoring, and also allows replacement or switching of cards as necessary in particular games described below.

During game play, a first card 12 is dealt to a player, and the player must decide which place on the board (of the nine possibilities) the card should be placed. In the example of FIG. 1 the player was dealt an Ace of Hearts as a first card 12. The player decided to put the first card 12 in the center position.

Once the player places the first card 12, a second card 14 is dealt to the player. In FIG. 1 a Jack of Spades was dealt as the second card 14. Again, the player must decide which position, of the eight remaining positions, to place the card (upper left corner). After each card is placed in a position, another card is dealt, and the player must decide in which of the remaining tic-tac-toe locations the dealt card must be placed.

When the game is complete and all nine cards have been dealt and placed, the nine cards will be laid out in three rows of three cards per row. By adding up the three card combinations, across, down and diagonally, (eight combinations in all) the player can calculate how many 21s he has created. In the example shown in FIG. 1, the only 21 created begins at the upper left card 14 (Jack of Spades) and moves diagonally down across the middle 12 (Ace of Hearts) to the lower right card 16 (King of Clubs). The other combinations have totals that are either greater than or less than 21.

The board will be sufficient size to be able to accommodate standard playing cards; however, a smaller board can be used for smaller cards. Further, as described above, a board is not necessary as the cards can be placed on a table in the correct location.

The novel board or gambling game utilizing a tic-tac-toe format could also be played as a poker game, instead of 21 as described above. In this alternative embodiment, the player places the cards as dealt onto the game board in an attempt to create the best poker hands using the three card combinations across, down and diagonal.

For example, if the player was initially dealt an Ace of spades, the player may place the Ace in the middle of the board. If the second card was an Ace of Hearts, the player may place that second Ace in the upper-middle position. If the third card dealt was the two of Hearts, the player may position the card in the upper-left location such that if another Heart is dealt, it can be placed in the upper-right position to complete the flush, if however another Ace is dealt, it can be placed in the lower-middle position for triple Aces. There are many different strategies that a player can use to play this tic-tac-toe type poker game. As described above, the player does not stop until all of the nine positions are filled. The player attempts to obtain as many winning poker hands as possible.

If the player placed the nine cards that he was dealt into the locations shown in FIG. 1, then the best hand the player has obtained the hand containing the Jack of Spades 14, the Queen of Hearts 18, and the Queen of Spades 20, otherwise known as a pair of Queens.

Similar to the games described above, a number of well-known card games can be played by utilizing the methods set forth herein, such as Blackjack and poker, using a standard deck of 52 playing cards. In the present invention, many of the existing strategies are present from classic card games; however, there are numerous additional strategies that can be implemented for successful game play. One of the key differentiators, and also one of the reasons for additional strategies, is because in the present invention a player must formulate both a strategy for the particular game play, along with a strategy for the location that the card is placed during the game play. The placement of the card becomes as important as the actual card dealt to the player.

Besides the general game play described above, there are many games and variations of games that can be played using the present invention. All the games and associated game play are based on the same principals as a Tic Tac Toe game, including the eight possible scoring opportunities in that classic game. In the present invention, just like the classic game, the player must create scoring opportunities using the three rows, the three columns, and the two diagonals.

Additionally, there are numerous games in accordance with the present invention which use the Xs and Os of the classic Tic Tac Toe game. In these types of games, the placement of the Xs and Os are combined with the placement of the particular cards in the present invention to create a novel game. As described above, all of the novel game embodiments can be incorporated and played with a standard deck of playing cards, as a handheld device, video or computer game (single-use or Internet version), on casino table games or gaming machines, using game boards, and also as lottery tickets, among others.

In the game play for Blackjack or 21 using the present invention, the basic play for each game involves dealing nine playing cards to a player one at a time (there may be multiple players playing at the same time) from a standard deck of 52 playing cards. There are a number of variations to this method; the player may have the option of discarding one or more of the dealt cards (i.e., not using the card dealt), placing one or more cards over an existing placed card, or rearranging the cards already placed down, depending on the game and the game options.

The game ends after nine cards have been placed in a three-by-three array similar to a game of Tic Tac Toe. The game variation may include a four-by-four array, or a five-by-five array, which may be useful for certain poker games. In the basic game play, the player must decide as each card is dealt where to place each card on a Tic Tac Toe layout, or a three-by-three array, in order to obtain as many as possible three card combination that add up to 21. The sums are created by adding up the card value for three cards across, down or on a diagonal. For example, if the resulting first column contains a seven of Diamonds, a four of Clubs and a ten of Hearts, the total is 21. There are eight different sums; three columns, three rows and two diagonals.

In the classic game of Blackjack or 21, as it is sometimes referred to, the value of the cards in a “hand” is added together and a total is determined. A winning hand has a value higher than the opponent or dealer that is less than or equal to 21. In the classic Blackjack game a player may receive as many cards as requested until the value of the cards in the players hand exceeds 21. The value of each card is equal to the number on the card for cards 2 through ten, i.e., the 3 of hearts has a value of three. The value of the face cards, the King, Queen and Jack, are set at ten, and the value of the remaining card, the Ace, can be one or eleven, depending on the player's choice. For example, if the three cards are the seven of Clubs, the Ace of Hearts and the three of diamonds, the player would choose to make the Ace worth eleven points. However, if the player's cards were the Ace of Hearts, the King of Clubs and the Queen of Spades, then the player would choose the value of the Ace to be one.

The present invention utilizes the same card values as the classic Blackjack game described above. However, in the present invention, the player has eight scoring opportunities or hands. One of the main differences between the present invention and the classic Blackjack game is that the player is only allowed three cards per hand, since each of the eight hands fit into a three-by-three Tic Tac Toe layout (unless more than a three-by-three layout is used). In the present invention the value of a winning hand, only three cards must equal 21.

The nine cards are dealt to complete the eight hands on the three-by-three layout. The player must attempt to place all nine cards in patterns of three that total 21. Eight hands of 21, a perfect score, is extremely difficult to obtain, since even if you were dealt each of the nine cards needed for the perfect score, the player must place the nine cards in the proper location on the nine card layout, or the eight hands of 21 can not be achieved.

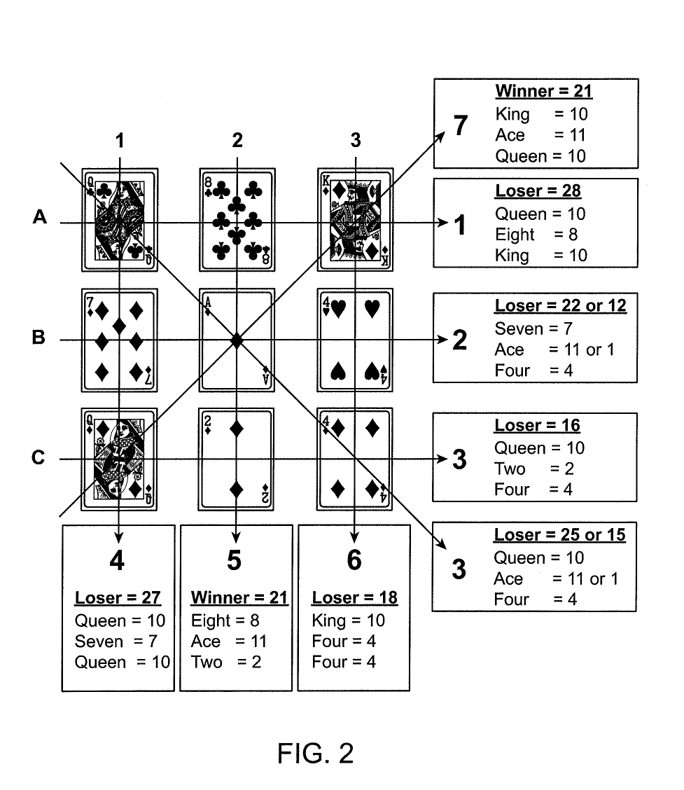

FIG. 2 shows a completed Blackjack or 21 game and an illustration of these scoring opportunities, or hands. For ease of reference, the rows are labeled A, B, C and the columns are labeled 1, 2, 3 to describe card placement. As such, the following eight hands are created:

| | | | | | Two Diagonal |
|---|---|---|---|---|---|
| | Three Vertical Hands | | Three Horizontal Hands | | Hands |
| 1 | Row A, Columns 1, 2, 3 | 4 | Column 1, Rows A, B, C | 7 | Cells A1, B2, C3 |
| 2 | Row B, Columns 1, 2, 3 | 5 | Column 2, Rows A, B, C | 8 | Cells, C1, B2, |
| 3 | Row C, Columns 1, 2, 3 | 6 | Column 3, Rows A, B, C | | A3 |

Each card placement is made to maximize the player's probability of arranging 9 cards into 8 possible scoring opportunities, either for Blackjack or poker depending on the game. Although the description herein relates mostly to a single player, it is easy to understand that these novel games can be played by more than one player at a time. The chart below, which uses the cells as described above, indicates one strategy involved in this particular game.

One alternative embodiment includes allowing a player to “pass” on the placement of a certain number of cards. Instead of being required to place each of the first nine cards dealt on to the three-by-three layout, the player can elect not place a certain number of the dealt cards, preferably five cards. In this embodiment, once a card is passed on, it can no longer be placed onto the layout. Players must decide whether of not each card dealt will help of hurt their score, and then elect to place the card on the three-by-three layout or “pass” on the placement of the card. Once the player has passed on a number of cards, for example, five cards, the player then must place the remaining cards on the layout until each of the nine places are filled.

In another alternative embodiment the game of poker is played using a similar nine-card method and the same three-by-three array layout. Of course, a four-by-four or five-by-five grid can be used without deviating from the present invention. In accordance with the present invention, nine playing cards are dealt to a player one at a time from a standard deck of 52 playing cards. The player must decide as each card is dealt where to place each card on the three-by-three layout in order to obtain the best eight, three card poker combinations when viewing the three rows, the three columns and the two diagonals. Again, the rules may allow for the player to pass or skip a number of cards before filling in the layout completely.

In poker certain card combinations create hands that have greater value than other hands. A winning hand is a hand that has a greater value than the opponent's hand. The present invention uses the same card values and the same ranking of the importance of certain hands as the classic game of poker. However, in the present invention, similar to the Blackjack game described above, there are eight scoring opportunities, or “hands” of only three card combinations (or four or five, depending on the game layout). Each scoring opportunity is a “hand” using three cards.

In the preferred embodiment of present invention, each hand can only have three cards, since the “hand” must fit into the three-by-three Tic Tac Toe layout. Nine cards are dealt to complete the eight hands on the layout of the present invention. The player must place all nine cards in patterns of three to have eight three card poker hands with the highest ranking card combinations possible. As in the Blackjack version of the present invention, the placement of cards on the layout is crucial to the result of all eight hands.

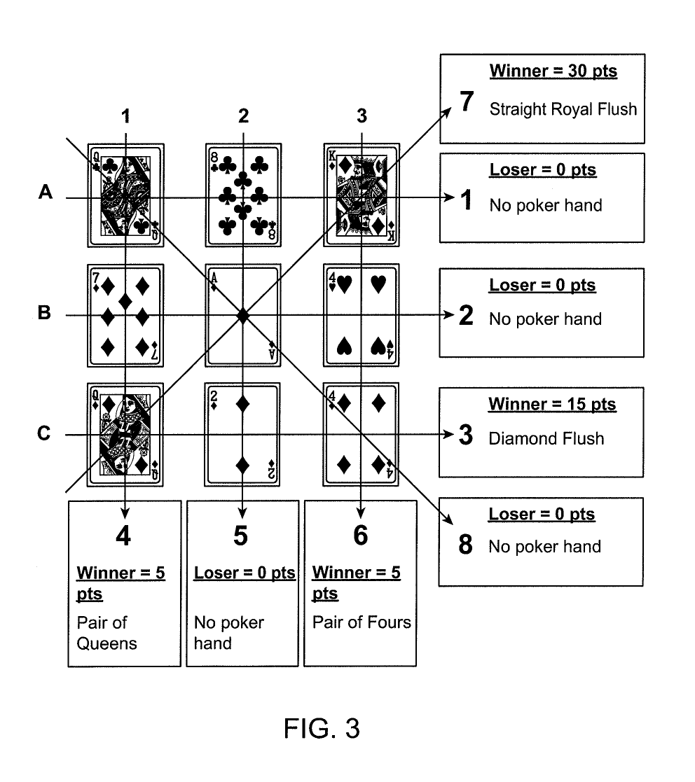

FIG. 3 shows a completed poker game in accordance with the present invention. Points are awarded and accumulated based on the “strength” of the three card poker hands, in other words, how good each three-card poker hand is. The lower the probability of achieving a hand the higher the point total awarded to achieving that hand. The chart below indicates one example of a scoring scheme.

| Description of Hand | Points Awarded |
|---|---|
| Royal Flush | 30 |
| Straight Flush | 25 |
| Three of a Kind | 20 |
| Flush | 15 |
| Straight | 10 |
| Two of a Kind | 05 |

Using the scoring above, the poker shown in FIG. 3 would be scored as follows:

| | | Points |
|---|---|---|
| Hand Number | Description of Hand | awarded |
| 1 | No hand | 0 |
| 2 | No hand | 0 |
| 3 | Diamond Flush | 10 |
| 4 | Pair of Queens | 5 |
| 5 | No hand | 0 |
| 6 | Pair of fours | 5 |
| 7 | Straight Royal Flush | 30 |
| 8 | No hand | 0 |
| | Total | 50 |

A player may be awarded another game if the score of the eight hands exceeds 30 points, for example. Players can then increase their cumulative score in a 2nd, ^{3rd,} 4^{th}, ₑt_{c}. game. Using this game play, a player could continue to play and accumulate points until the score for their game was less than 40 points. The game only ends when the score achieve in one round is less than 30. Using this feature, players can continue to try to match or beat the highest score that the player had previously achieved, or if the player is networked to other players, i.e., over the Internet, the player can try to match or best the highest score ever for that particular type of game.

Another alternative embodiment of the present invention would include a type of gaming machine in which a pay table would be calculated. Players would insert coins or other types of credit and receive payouts (winnings) based on the resulting hand (and based on the pay table). A player that has a high pay table score would be eligible to participate in another “hand” that would be part of a “progressive” payout. The progressive would represent a very large amount that could be won. The progressive would be tied to a network of other gaming machines in accordance with the present invention.

The points awarded by hand and the threshold amounts (to be rewarded with another game) can be adjusted based on the results to increase the frequency and amount of winning hands during game play. The frequency and amount of winnings are calculated in accordance with known parameters for the gaming industry.

The chart below shows one of the many strategies involved in playing the present invention for the game of poker. In particular, the strategy includes where and why certain cards are placed in certain positions in the layout.

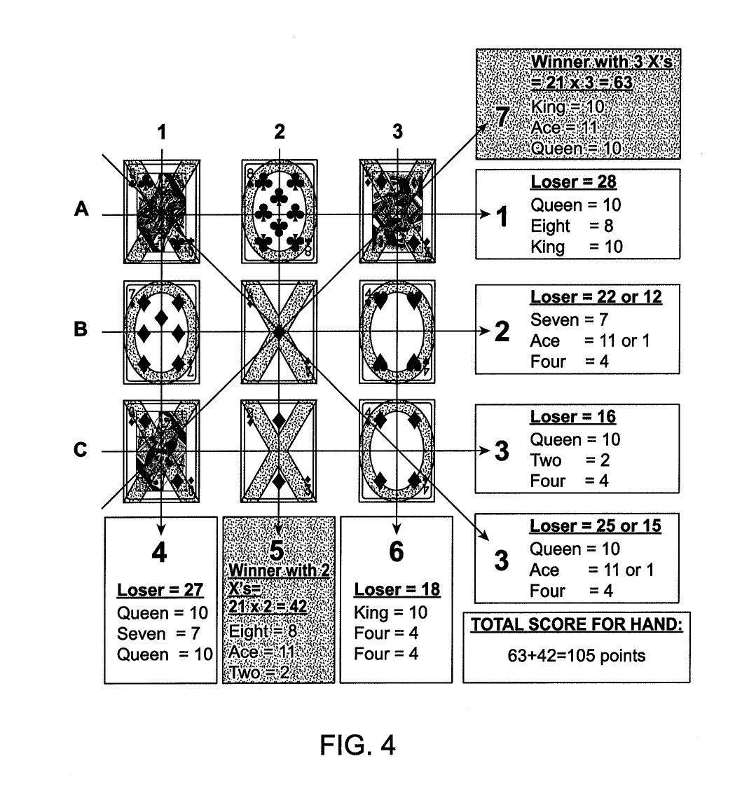

FIG. 4 shows another alternative embodiment is a game of the present invention played with both regular playing cards and cards or some other indicators of Xs and Os as used in a standard game of Tic Tac Toe. The Xs and Os serve as a point multiplier in which one player may play against another player, or against a computerized system using a “computer dealer”.

The object of the game is to create as many “hands” that total to 21 as possible on the Tic-a-Tac grid while at the same time placing Xs (or Os) on those cards. Point totals for “hands” are multiplied by the number of Xs on the cards within the three card hand that totals 21. For example, if all three cards in a sequence that total 21 have Xs, the total would be multiplied by three, resulting in a point total of 63 (21×3=63) for that particular hand. If only two cards in the three card 21 sequence have Xs the result would be a point total of 21×2=42 for that particular hand. The player receives no points for a three card hand that totals to 21 if the player failed to place any Xs on any of the cards in the sequence.

Another alternative embodiment of the present invention can be played in two parts that are related to each other. The first part is a standard game of Blackjack played against the dealer. The winner of the Blackjack hand determines where and what card is placed on the three-by-three layout in the second part of the game.

During the second part of the game, cards are placed on the layout based on the results of the Blackjack game played in part one. If the player beats dealer in the Blackjack game then the player may place any card in his Blackjack hand on any space on the layout. Further, an X is placed on top of that card. If the dealer wins the Blackjack hand, then a random card, from the dealer's hand, is randomly placed on a space on the layout and an O is placed on top of that card. The player attempts to maximize his Blackjack score by creating as many three-card hand sequences as possible that have as many Xs on the layout.

To the extent that game play is via computer, the play could start with one blank three-by-three layout and one standard deck of 52 playing cards, for example, the three-by-three layout can be prominently displayed at the top and center of the screen. Along either sides of the bottom of the computer screen the Blackjack game will be played by the player and dealer. The player is dealt two cards, and the dealer is dealt two cards. One of the dealer's cards is dealt face down and the other is dealt face up. The player then plays Blackjack against the dealer, with the object to get a total card count of less than or equal to 21 that is greater than the dealers card count. If the player exceeds 21 the dealer wins.

If the player defeats the dealer during the Blackjack game, the player is allowed to place one of the cards in his hand on any open space on the layout. The player may use a placement strategy that will provide the best chance to have a three card total of 21 for as many of the 8 possible hands in the layout. The player also receives an X on top of the card that the player placed in that position.

If, on the other hand, the dealer wins the Blackjack hand, the computer randomly places one of the dealer's cards on one of the open spaces on the layout. The system can be programmed to strategically choose which card is placed and where it is placed, thereby reducing the player's chance to obtain a 21 on that section of the layout. The Computer places an O on top of the placed card. These steps are repeated until the entire layout is completed. The player's score is based on the number of 21s and the multiplier based on the number of Xs in each 21.

The game ends when nine cards are placed on the layout. The player receives a score based on the number of three card hands that total 21, with a multiplier based on the number of X's on those cards that total 21, as described above.

As described above, it is very difficult to get eight-three card sequences on the grid that total 21, it would be even harder to get all eight-three cards sequences to total to 21 and to have beaten the dealer on all nine hands, thereby placing an X on all nine spaces on the grid. This score of 504 would be a highest obtainable for an individual game, however, the score could be bettered if each player was allowed to get another game to add any point total from the first game to the second game. This would allow for increasing points totals for individual players.

Another alternative embodiment involves similar rules, but played against an opponent. Thus, this alternative embodiment is played with both regular playing cards and Xs and Os as used in a Tic Tac Toe game. Further, other symbols can be implemented for more than two players in this version depending on the number of participants in the game. The Xs, Os and other symbols serve as the point multiplier as described above. In the preferred embodiment, this game is played on a computerized system in competition with other players.

The object of the game is to create as many 21 hands as possible on the layout while at the same time placing the player's designated symbol on those cards. Point totals for each hand is multiplied by the number of the player's symbols on the cards within the three card 21 hand. As an example if all three cards in a 21 sequence all have the player's symbol, that player would receive 63 points (21×3) for that particular hand. If only two cards in a three card 21 sequence have the player's symbol, that player would receive 24 points, and the player receives no points for a three card 21 hand if none of the player's symbols have been placed on any of the cards in the sequence.

In an alternative embodiment, the game is played against other players instead of a computer. Again, the invention includes two parts that are related to each other. The first part is a standard game of Blackjack played against all the other players. The winner of the initial Blackjack hand determines where and what card is placed on the three-by-three layout for the second part of the game. The first part would include a tie breaker rule, and up to six players could participate, with four players being the optimal amount. At the beginning of the game, each player chooses or is assigned a symbol, such as X, O, +, etc.

During the second part of the game, cards are placed on the layout based on the results of the Blackjack game from part one. The player that wins the hand from part one can place any card in his winning hand on any unused space on the layout and then his symbol is placed on top of that card. The player attempts to maximize his score by creating three card sequences that add up to 21, and that have his symbol on as many of those cards as possible.

Play starts with one empty three-by-three layout and one standard deck of playing (52 cards). The present invention can be played on a game board, on a computer, on a cell phone or PDA, on bar-top devices, on a handheld computer device, and over the Internet either against the computer or against other players networked together.

Another alternative embodiment includes a version using the three-by-three layout for the game of poker. The method is similar to the invention described above, but instead of attempting to obtain a hand that totals 21, the player attempts to obtain various poker hands, which have different values depending on the difficulty of obtaining that hand. As in the two part game for 21, the score for each poker hand is multiplied by the number of Xs (or the player's symbol) placed on the cards of each of the eight possible three-card hands.

This alternative embodiment is similar to the game of poker described above, played with regular playing cards and Xs and Os as used in a game of Tic Tac Toe. The Xs and Os serve as multipliers to increase the player's score. The player uses the X symbol and the dealer uses the O symbol.

The object of the game is to create as many poker hands as possible on the layout while at the same time placing your symbol on those cards. The better the poker hand, the more points are possible (which are increased by the multiplier). The player earns the right to place an X on the layout by beating the dealer's poker hand. If the player is using the X as the symbol, the dealer will use the O symbol. Different values can be assigned to various poker hands, as described above. The point totals for the poker hands are multiplied by the number of symbols (Xs, Os or other symbols) on the cards within the 3 card hand. For example, a flush hand has a poker hand value of 15. If, during game play, a player places two Xs on those cards, the point total would be multiplied by two, resulting in a point total of 15×2=30. The player does not receive any points for a three card poker hand that has no Xs placed on any of the cards in the sequence.

Similar to the embodiment set forth above, this method of the present invention is played in two related parts. The first part is a standard poker game that incorporates three cards dealt against the dealer. The hand with the greater poker value is the winner. This could be stud poker (no chance for additional cards) or draw poker; the player can return certain cards for new cards from the deck. The system can be set up so that ties are won by the player.

During the second part of the game, the winner of the best poker hand from the first part is allowed to place one of the winning cards on to the layout. The player attempts to maximize his score by creating as many high value three-card poker hands as possible, and placing as many of his symbols on those hands.

As an example of game play (there are many others), both the player and the dealer are dealt three cards, one face up and two face down. Both the player and the dealer may choose to discard up to two of the three cards dealt or keep all the cards as they were originally dealt. Any discarded cards are replaced by the dealer with new cards from the deck.

Once the player and the dealer have received their final cards, the hands are disclosed and the winner of the poker hand will have the highest three card poker value. The winner of the hand determines where and which card in his three card poker hand is placed on the layout. If the player beats the dealer in the standard three card poker game then the player may place any card in his poker hand on any unused or remaining open space on the layout. Also, an X (the player's symbol) is placed on top of that card. However, if the dealer wins the three card poker hand, then the dealer (or computer) will place any card in the dealer's hand on any remaining open space on the layout, with the dealer's symbol, the O, placed on top of that card. The computer dealer can either place a random card on the layout randomly, or the system can be programmed to place the best card in the best position to block or otherwise retard the player's strategy.

As with the other embodiment, there are 9 hands of three card poker played. One hand to determine the card and space for each of the spaces on the three-by-three layout.

The game ends when all 9 card spaces on the layout have been filled with cards (and symbols). The player receives a score based on the point value of all the three card poker hands and the number of Xs (or the player's symbol) on those cards.

Players can be awarded another game if their score exceeds 40 points for the game. Players can then increase their cumulative score in a 2nd, 3rd, 4th, game, etc. Using this type of game play and scoring, a player could continue to play and accumulate points until the score for their game was less than say 40 points. The game only ends when the score achieve in one round is less than 40. This embodiment can likewise be played with numerous players against each other, as long as each player has a distinguishing symbol to be placed on the card selected when the winning hand in part one is determined.

In another alternative embodiment, the game of Texas Hold 'em is combined with the game of Blackjack or 21. In this embodiment, between two and four players play the game. The object of the Game is to win all the money bet during the game by continuing to bet and stay in the game, and having the most hands of 21 on the layout.

Each player is dealt two cards face down. These are the player's cards, with the remaining 7 cards considered to be the community cards. A certain number of the 7 community cards are placed on the three-by-three layout in various rounds during the game. The space where each card is placed is determined at random. For a computer version of this game, a random number generator is used to place the cards on an empty space on the layout. For a game board version of this game, nine cards numbered 1-9 are drawn and placed next to each community card to determine the space on the layout where each card will to be placed. Players bet after each round while evaluating their chances of having the most hands that equal 21. As with the poker game of Texas Hold 'em, players can go “all in” during any round, or decide to fold.

In the last round, the remaining players place their “hole” cards on the remaining two open spaces on the layout to complete the layout and the game. The player with the most hands of 21 wins the game.

At the beginning of each game, each player places the minimum ante bet in the pot. At any point during the game, after the ante bet, a bet may be placed. Also, a player may go “all in”, wagering all their “chips” upon any of their opportunities to place a bet. Once the ante is in, each player is dealt two “hole cards” face down so no one else can see their cards, and these cards will not be placed on the layout until the end of the game. Each player looks at his cards and evaluates the chances of having a 21 hand and/or a good formula to complete the layout. The betting can begin with a “pre flop” bet. To remain in the game all players must match the highest amount bet by another player. A player may match the bet, raise the bet or choose to drop out of the game.

Next, five community cards, called the “flop,” are dealt and placed at random on various positions on the layout. If the game uses a computer, a random number generator is used to place the cards on a space on the board. For a board game version, some way to determine a value from one to nine is used for each card. In the preferred embodiment, nine cards numbered 1-9 are shuffled, drawn and placed next to each community cards to determine the space on the layout where each card will be placed. Next each player looks at his cards and evaluates his/her chances of having a 21 hand and/or a good formula to complete the layout. Next, each player (in order) may make a bet, raise a bet or drop out of the game.

The next card is also a community card and is called the “turn.” It is dealt and placed at random on the layout. Again, each player looks at his/her cards and evaluates his/her chances of having a 21 hand and/or a good formula to complete the layout. A new round of betting ensues. Finally, a single community card called the “River” is dealt and placed at random on the layout. Thus, seven cards are now placed randomly on the three-by-three layout leaving two empty spaces. Again, each player evaluates the two hole cards in relation to the seven community cards makes a bet, raises the bet or drops out of the game. Of course, a different amount of cards can be dealt at each stage of the game, so for example, four cards can be used for the flop, two cards can be used for the turn, and one card for the river. Alternatively, at each stage, only one card may be dealt thereby increasing the number of betting opportunities (one for each of the seven cards dealt).

After the final round, there are two open spaces remaining on the layout. If more than one player remains in the game at this time, the winner of the hand is determined by evaluating which player has the most hands of 21 on the layout, by placing the hole cards into the remaining spaces. It is the responsibility of the player to determine which of the two spaces results in the most hands of 21. In a determined order, the players place their hole cards on the grid and announce how many 21 hands they have created. The cards are removed, and the next player does the same. This play continues until all the remaining players have placed their hole cards on the grid. The player with the most hands of 21 wins the hand. If the players have the same number of 21 hands, the pot is split between them.

Likewise, an alternative embodiment of the present invention includes the three-by-three layout and the game of Texas Hold 'em for poker. The game is played by at least 2 players, and the object is to win all the money bet during the game. This object is accomplished by continuing to bet and stay in the game, and having the highest value three card poker total placed on the layout.

In the same manner as described above, players are each dealt two cards face down. These are the player's cards, with the remaining seven cards being community cards. During game play, a certain number of the seven community cards will be placed randomly on the layout as described above. Players bet after each round while evaluating their chances of having poker hands with the highest value. Players can go “all in” during any round, or fold and be out of the game.

In the last round, any players remaining in the game place their hole cards on the remaining two open spaces on the layout to complete the game. The player with the highest three card poker hand total points wins the game.

In the alternative embodiment, each player begins by placing the minimum ante bet in the pot. Each player is then dealt two hole cards face down, so no one else knows the cards' value. These cards will not be placed on the layout until the end of the game. At this point, each player looks at his cards and evaluates the chance of having the best and highest valued three card poker hands, along with a good strategy for completing the layout. The betting is accomplished as set forth above, with similar parameters for the flop, turn and river cards.

After all of the seven cards have been dealt, and there are two empty spaces, and after all of the betting has taken place, the winner of the hand is determined by evaluating which player has the highest point total for all the three card poker hands on the layout after placing the player's cards on the remaining two spaces on the layout. If two or more players have the same point totals, the pot is split between them.

In another alternative embodiment, the same Blackjack or poker game is played as described above, however, as the player places cards into one of the nine spaces, if the total of the row, column or diagonal equals 21 (or in the poker game, a qualifying hand), the cards are removed and the total number of 21s is increased by 1 (or the poker total is increased by the poker hand score). The player continues placing cards until there are no more spaces to be filled. For example, as the player places cards on the three-by-three grid, the first column contains a seven, eight and six (or total of 21), those three cards are removed (to allow for additional cards to be placed in those spaces) and the total number of 21s increases by one. In the game of poker, the second column contains the three, five and nine of Hearts, so those cards are removed, and the total score is increased by 15 (the score for a flush in the scoring chart above).

This removal of scoring or winning cards can continue until the spaces all contain non-scoring hands. Further, the present invention may allow for a player to view a completed grid, and be allowed to switch cards to increase the number of 21s or the poker score. This switching can be done with or without the replacement of cards when a winning hand is created, and can be timed to provide only a certain amount of time for a player to make the switches. As an example, a grid is provided for a player that has no 21s. The player switches the first two cards in the first column to create two rows of 21. Those six cards may then be removed (with the total 21s increased by two) and six new cards appear for the player to switch around. Again this game can be timed to provide the player only three minutes, for example, to make all the necessary switches.

In another alternative embodiment, the player is provided a number of cards and a timer to place the cards into the optimal spaces to create the most 21s or the best poker hands in the least amount of time. Points can be removed (or added 0 based on the amount of time it takes to fill the grid, thus filling the grid quickly with less 21s, for example, may generate a higher score than taking a longer amount of time to generate the most 21s possible.

The present invention, both the Blackjack and poker embodiments, can be played on numerous different devices, for example, a handheld video device or a computer screen (not shown). A reproduction of the playing cards can be dealt or displayed, and the player can decide which location in which to place the card. The software for such a game could be distributed by either CD-ROM (or another medium), or downloaded from the Internet. Further, the game could be played online, either with gambling or without.

This novel game play can also be applied to the gaming industry, allowing a player to insert coins, or otherwise bet, prior to or during the game play. The various payouts would be determined based on the amount gambled, and the number of 21s attained (or possible based on the fewer cards to reach a 21).

The novel game play may also be utilized in a television game show format. The contestants are dealt a card from the deck and place that card in one of the nine locations. The cards can be displayed to the contestants and the audience by using large easily readable cards, or monitors that display the card when that location is selected.

Both of the above-described games can be played with a standard, nine-position tic-tac-toe type board or playing field. However, these games can also be played on a board or field that contains four or five (or more) across or down. In an alternative embodiment, where a five by five position board is used (not shown), a game similar to stud poker can be played with five poker hands across, five poker hands down, and two diagonal hands.

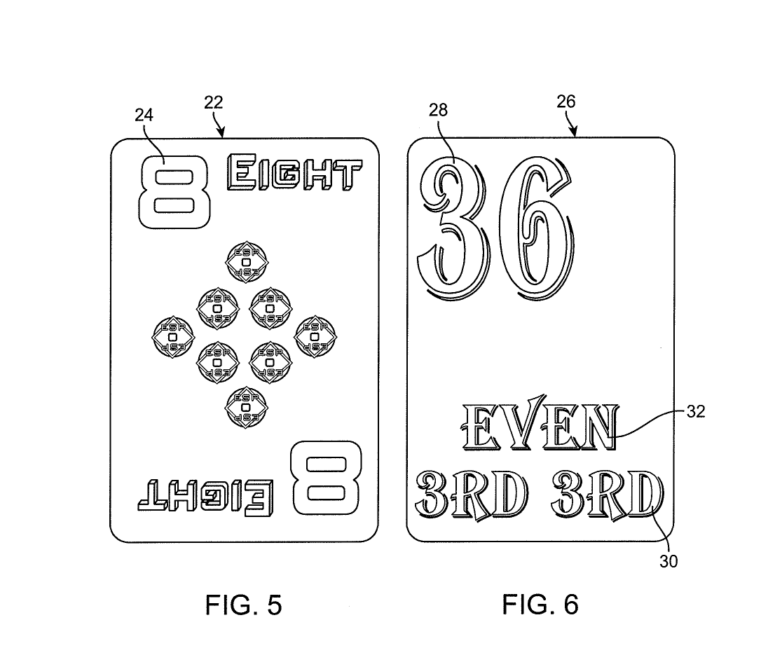

An alternative embodiment of the present invention relates to a novel deck of playing cards made up of 60 individual cards, divided into six groups of ten cards per group. FIG. 5 shows a card 22 in accordance with the alternative embodiment of the present invention. Each card 22 of each group has a numeric value 24 between one and ten (i.e., six cards having the number five, six cards having the number ten, etc.) The card 22 shown in FIG. 5 has the numeric value of eight. These cards do not necessarily need a suit indication (Club, Spade, Diamond or Heart) as found on cards from a standard playing deck of cards. Of course, other combinations of numeric values and group numbers can be used, such as ten groups of cards each card containing the numeric value of between one and seven.

In using this deck to play a game, after the novel deck is shuffled and the cards are in a random order, the dealer deals a card up with the numeric value of that card showing. The player then attempts to guess whether or not the next card to be dealt will have a numeric value that is higher or lower (or possibly the same value) than the initial card. If the player guesses correctly, he may choose to continue. Each guess is based on whether the player believes that the next card dealt will be higher or lower than the previously dealt card. The winner of the game is the player that can predict the largest number correctly in a row.

These novel cards can also be used in the gaming industry as table games (i.e., a dealer deals cards to a player or players sitting around the table), for video gaming machines, on handheld video devices or computers (either CD-ROM, or downloaded from the Internet) for game play. In these instances, the payout may be determined based on the types of correct guesses (high-low, numeric value), the number of correct guesses (possibly in a row), and the amount initially wagered.

FIG. 6 shows another card 26 from another alternative embodiment of the present invention. The novel deck of playing cards contains a number of these novel cards 26. In the preferred embodiment, the novel deck contains either 37 or 38 cards 26. Each card 26 has a number 28 on its face. The number in the preferred embodiment is between one and 36, or 0 or 00. Each card 26 contains an indication of color on its face (not shown). The colors on the cards 26 in the preferred embodiment are black, red or green (based on the number 28). In the preferred embodiment, these cards 26 also contain other information, including whether the card is in the group 30 of cards labeled first-third (cards having numbers one through 12), second-third (cards having numbers 13 through 24), or third-third (cards having numbers 25 through 36). The 0 and 00 cards do not have such a group 30 indication. In the preferred embodiment, the cards also have an indication 32 that shows whether the card is even or odd (based on the number 28). These cards contain information similar to the information found on a roulette table.

If there is only one zero card, then the preferred deck contains 37 cards; if there is also a double-zero card, the preferred deck contains 38 cards. For example, one card would contain the number seven, the indication of odd, and the color black, while another card would contain the number 14, an indication of even, and the color red. With this novel deck of cards, a roulette-type game (or gambling game) could be played. Instead of rolling the ball on a roulette wheel to determine the winner of the game, the dealer shuffles the deck and turns over a card; the odds are similar to those in roulette. However, in alternative game play, if the deck is not shuffled after each deal, the odds of a particular card being turned up changes after each deal.

Of course there are other games that can be played using the roulette deck. A player may try to predict whether the next card to be turned up will be higher or lower than the previous card, or whether the next card turned up will be red, black, green, odd, even, first-third, second-third, or third-third, etc. Each guess will be worth a different value depending on the odds. As long as a player guesses correctly, he can continue to guess.

Similar to the first set of novel cards, these roulette cards can also be utilized in the gaming industry as table games, video gaming machines, handheld video devices or on computers (either CD-ROM, or downloaded from the Internet) for game play. In these instances, the payout is determined based on the types of correct guesses (high-low, numeric value, odd-even, color, etc.), the number of correct guesses (possibly in a row), and the amount initially wagered.

Further, the Blackjack, poker, and novel card embodiments can be utilized as lottery tickets, where the player scratches off the opaque layer in order to reveal the playing cards underneath. In Blackjack, if the player's combination of numbers equals 21, the player wins. The more combinations that add to 21, the more times the player wins. The same holds true for the poker embodiment. A certain hand could decide the winner (pair of jacks or better). The player can win multiple hands.

The foregoing detailed description of the invention is intended to be illustrative and not intended to limit the scope of the invention. Changes and modifications are possible with respect to the foregoing description, and it is understood that the invention may be practiced otherwise than that specifically described herein and still be within the scope of the claims.

What is claimed is:

1. A method of playing a card game wherein the object is to accumulate nine cards making up of eight sets of three cards wherein each card is used in more than one of said eight-three card sets, comprising the steps of:
a) dealing a playing card from a deck of playing cards to a player;
b) placing said playing card in one of nine locations, said one of nine locations being determined by a three by three array;
c) dealing another playing card to said player;
d) placing said another playing card into a remaining location of said nine locations;
e) repeating steps c) and d) until each of said nine locations contain a playing card.

2. The method of playing a card game in claim 1, further comprising the step of:
f) scoring each of said eight sets of three cards based on a poker scoring table.

3. The method of playing a card game in claim 2, further comprising the step of:
g) adding up the scoring from each of said eight sets of three cards to generate a total score for said card game.

4. The method of playing a card game in claim 3, further comprising the step of:
h) determining a reward based on the total score.

5. A method of playing a card game wherein the object is to accumulate nine cards making up of eight sets of three cards wherein each card is used in more than one of said eight-three card sets, comprising the steps of:
a) dealing a playing card from a deck of playing cards to a player;
b) deciding whether to discard the playing card or not;
b) if not discarded, placing said playing card in one of nine locations, said one of nine locations being determined by a three by three array;
c) dealing another playing card to said player;
d) placing said another playing card into a remaining location of said nine locations;
e) repeating steps c) and d) until each of said nine locations contain a playing card.

6. The method of playing a card game in claim 5, further comprising the step of:
f) scoring each of said eight sets of three cards based on a poker scoring table.

7. The method of playing a card game in claim 6, further comprising the step of:
g) adding up the scoring from each of said eight sets of three cards to generate a total score for said card game.

8. The method of playing a card game in claim 7, further comprising the step of:
h) determining a reward based on the total score.
